(19) United States
(12) Patent Application Publication
(10) Pub. No.: US 2025/0015366 A1
(43) Pub. Date: Jan. 9, 2025

(54) POWER STORAGE CELL

(71) Applicant: TOYOTA JIDOSHA KABUSHIKI KAISHA, Toyota-shi (JP)

(72) Inventors: Yusuke IKEDA, Miyoshi-shi (JP); Kazuhito KATO, Toyota-shi (JP); Takaaki GOTO, Seto-shi (JP); Masayoshi HAGA, Nagoya-shi (JP); Minehiro FUNATO, Toyota-shi (JP); Tsuyoshi KANEKO, Nisshin-shi (JP); Yuka YOKOI, Nagoya-shi (JP)

(73) Assignee: TOYOTA JIDOSHA KABUSHIKI KAISHA, Toyota-shi (JP)

(21) Appl. No.: 18/734,647

(22) Filed: Jun. 5, 2024

(30) Foreign Application Priority Data
Jul. 3, 2023 (JP) 2023-109155

(51) Int. Cl. H01M 10/42; H01M 4/13; H01M 10/0583; H01M 50/431; H01M 50/443; H01M 50/446; H01M 50/449; H01M 50/46; H01M 50/466

(52) U.S. Cl. CPC H01M 10/4235; H01M 4/13; H01M 10/0583; H01M 50/431; H01M 50/443; H01M 50/446; H01M 50/449; H01M 50/46; H01M 50/466

(57) ABSTRACT

The power storage cell includes a case, an electrolyte solution, and an electrode assembly. The electrode assembly includes a first electrode, a second electrode, a separator, and an interposition film. The first electrodes and the second electrodes are alternately stacked. The separator separates the first electrode from the second electrode. The interposition film is interposed between the first electrode and the separator. The interposition film includes a first region and a second region in a plane orthogonal to the stacking direction of the first electrode and the second electrode. The first region includes the center of the interposition film in a plane. The second region surrounds the periphery of the first region. The interposition film satisfies the relationship of the formula (1) “T2<T1”. T1 represents the thickness of the interposition film in the first region. T2 represents the thickness of the interposition film in the second region.

### CROSS REFERENCE TO RELATED APPLICATIONS

This nonprovisional application is based on Japanese Patent Application No. 2023-109155 filed on Jul. 3, 2023 with the Japan Patent Office, the entire contents of which are hereby incorporated by reference.

### BACKGROUND

### Field

The present disclosure relates to a power storage cell.

### Description of the Background Art

Japanese Patent Application Laid-Open No. 2019-079661 discloses a stacked electrode assembly.

### SUMMARY

A power storage cell may include a case, an electrolyte solution, and an electrode assembly. The case houses the electrolyte solution and the electrode assembly. The electrode assembly can be roughly divided into a “stacked type” and a “wound type”. The wound type can be formed by spirally winding a strip-shaped electrode group. The stacked type can be formed by stacking electrode groups in one direction.

The electrode assembly includes a separator. The separator is disposed between electrodes. The separator is porous. When the electrolyte solution permeates the separator, the electrolyte solution can be retained in a gap between the electrodes.

The electrolyte solution may be leaked from the electrode assembly. In the stacked type, the gap between the electrodes is opened at its entire perimeter in a direction orthogonal to the stacking direction. For example, when the stacking direction is orthogonal to a vertical direction, the electrolyte solution can be moved vertically downward by an action of gravity. The electrolyte solution may be leaked from the opened gap vertically downward. It is considered that the leakage of the electrolyte solution causes unevenness in a retention amount of the electrolyte solution in a plane orthogonal to the stacking direction.

It is an object of the present disclosure to reduce the unevenness in the retention amount of the electrolyte solution.
1. A power storage cell according to one aspect of the present disclosure includes the following configuration. The power storage cell includes a case, an electrolyte solution, and an electrode assembly. The case houses the electrolyte solution and the electrode assembly. The electrode assembly includes a first electrode, a second electrode, a separator, and an interposition film. The first electrode and the second electrode are alternately stacked. The separator separates the first electrode from the second electrode. The interposition film is interposed between the first electrode and the separator. In a plane orthogonal to the stacking direction of the first electrode and the second electrode, the interposition film includes a first region and a second region. The first region includes a center of the interposition film in the plane. The second region surrounds a periphery of the first region. The interposition film satisfies a relationship of the following formula (1):

T2<T1 (1).
T1 represents a thickness of the interposition film in the first region. T2 represents a thickness of the interposition film in the second region.

In one aspect of the present disclosure, the electrode assembly includes the interposition film in addition to the electrode and the separator. The interposition film has a specific thickness distribution. That is, the first region (center) of the interposition film is thicker than the periphery thereof. Movement of the electrolyte solution around the first region can be blocked by the first region. Since the movement of the electrolyte solution is blocked, unevenness in the retention amount of the electrolyte solution is expected to be reduced.
2. The power storage cell according to “1” may include, for example, the following configuration. The power storage cell has a height direction, a width direction, and a thickness direction. The height direction, the width direction, and the thickness direction are orthogonal to one another. The thickness direction is parallel to the stacking direction. In the plane orthogonal to the stacking direction, the first region extends in the width direction. The second region includes a third region and a fourth region. The first region is disposed between the third region and the fourth region in the height direction.

The interposition film further satisfies a relationship of the following formula (2).

T3<T4 (2)
T3 represents a thickness of the interposition film in the third region. T4 represents a thickness of the interposition film in the fourth region.

Since the first region extends in the width direction, the movement of the electrolyte solution can be blocked in a wide range. Further, since the third region (thin portion) exists on one side of the first region (thick portion) in the height direction, the electrolyte solution is expected to be stored in the third region. With a synergy of these effects, it is expected to reduce the unevenness in the retention amount of the electrolyte solution.
3. The power storage cell according to “2” may include, for example, the following configuration. The interposition film further satisfies relationships of the following formulas (3) and (4).

$$10 μm \leq T 1 \leq 20 μm \qquad ( 3 )$$

$$T 3 \leq 3 μm \qquad ( 4 )$$

4. The power storage cell according to any one of “1” to “3” may include, for example, the following configuration. The interposition film is formed on a surface of at least one of the first electrode and the separator. The interposition film is porous. The interposition film includes an inorganic particle and a binder.
5. The power storage cell according to any one of “2” to “4” may include, for example, the following configuration. The separator includes a serpentine portion. In the serpentine portion, the separator is folded in a serpentine manner. The separator is folded back at both ends in the height direction. The separator is folded back to alternately sandwich the first electrode or the second electrode.

The following describes an embodiment (hereinafter, also simply referred to as “the present embodiment”) of the present disclosure. It should be noted that the present embodiment does not limit the technical scope of the present disclosure. The present embodiment is illustrative in any respect. The present embodiment is non-restrictive. The technical scope of the present disclosure encompasses any modification within the scope and meaning equivalent to the descriptions of claims. For example, it is initially expected to freely extract configurations from the present embodiment and combine them freely.

Geometric terms should not be interpreted in a strict sense. Examples of the geometric terms include “parallel”, “vertical”, and “orthogonal”. For example, the term “parallel” may be deviated to some extent from the strict definition of the term “parallel”. The geometric terms can include, for example, a tolerance, an error, and the like in terms of design, operation, manufacturing, and the like. A dimensional relation in each of the figures may not coincide with an actual dimensional relation. In order to facilitate understanding of the reader, the dimensional relation in each figure may be changed. For example, length, width, thickness, or the like may be changed. Further, part of configurations may be omitted.

A numerical range such as “m to n %” include values at both ends unless otherwise stated particularly. That is, “m to n %” indicates a numeric value range of “m % or more and n % or less”. The expression “m % or more and n % or less” includes “more than m % and less than n %”. The expressions “or more” and “or less” are each denoted by a sign of inequality with an equal sign, i.e., “≤”. The expressions “more than” and “less than” are each denoted by a sign of inequality with no equal sign, i.e., “<”. A numerical value freely selected from the numerical range may be employed as a new upper or lower limit value. For example, a new numerical range may be set by freely combining a numerical value described in the numerical range with a numerical value described in another portion of the present specification, table or figure.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view showing an example of a power storage cell according to the present embodiment.

FIG. 2 is a schematic cross-sectional view showing an example of a power storage cell according to the present embodiment.

FIG. 3 is a cross-sectional view showing an example of an electrode assembly according to the present embodiment.

FIG. 4 is a schematic plan view showing an example of an interposition film.

FIG. 5 is a cross-sectional view taken along line A-A of FIG. 4.

FIG. 6 is a cross-sectional view taken along the line B-B of FIG. 4.

FIG. 7 is a cross-sectional view taken along the line C-C of FIG. 4.

### DESCRIPTION OF THE PREFERRED EMBODIMENTS

### —Power Storage Cell—

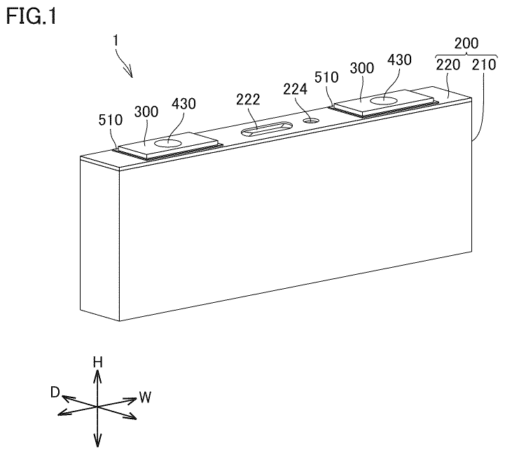

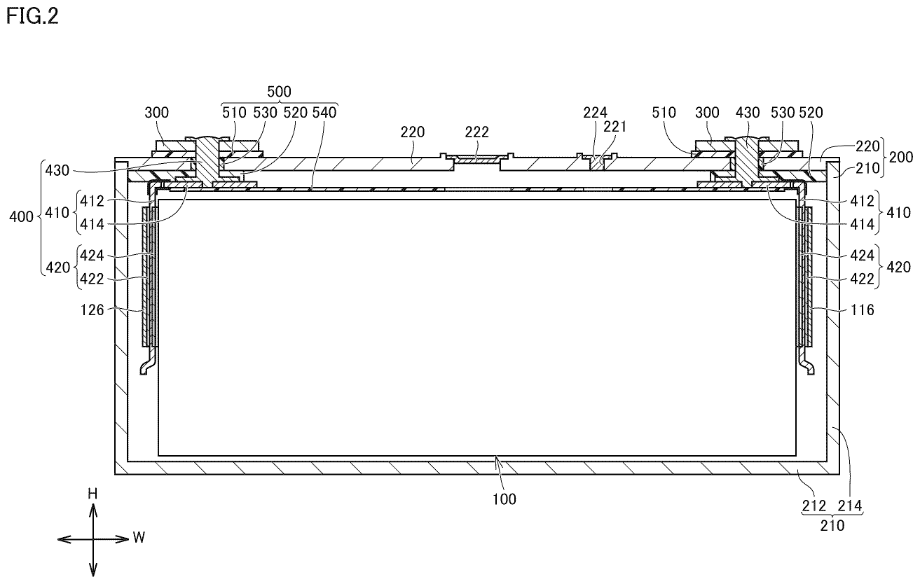

FIG. 1 is a schematic perspective view showing an example of a power storage cell according to the present embodiment. FIG. 2 is a schematic cross-sectional view showing an example of a power storage cell according to the present embodiment. The power storage cell 1 may have, for example, a height direction, a width direction, and a thickness direction. The height direction, the width direction, and the thickness direction are orthogonal to each other. The “height direction” is the H direction in FIG. 1 and the like. The “width direction” is the W direction in FIG. 1 and the like. The “thickness direction” is the D direction in FIG. 1 and the like. The height direction may be, for example, parallel to the vertical direction. The width direction and the thickness direction may be, for example, parallel to the horizontal direction. “Height” indicates a dimension in the height direction. The “width” indicates a dimension in the width direction. A “thickness” indicates a dimension in a thickness direction or a thickness of an object.

The power storage cell 1 includes a case 200, an electrolyte solution (not shown), and an electrode assembly 100. The electrolyte solution is a liquid electrolyte. The electrolyte solution may contain, for example, an organic solvent and a lithium salt.

### —Electrode Assembly—

The electrode assembly 100 may have, for example, a rectangular parallelepiped outer shape. The “first aspect ratio” indicates a ratio of a width to a height in the electrode assembly 100. The first aspect ratio may be any of, for example, 1 or more, 1.5 or more, 2 or more, 2.5 or more, 3 or more, 5 or more, or 10 or more. The first aspect ratio may be any of, for example, 10 or less, 5 or less, 3 or less, 2.5 or less, 2 or less, or 1.5 or less. The “second aspect ratio” indicates the ratio of the thickness to the height of the electrode assembly 100. The second aspect ratio may be, for example, 0.1 or more, 0.2 or more, 0.3 or more, 0.5 or more, or 1 or more. The second aspect ratio may be, for example, 1 or less, 0.5 or less, 0.3 or less, or 0.2 or less.

### —First Electrode and Second Electrode—

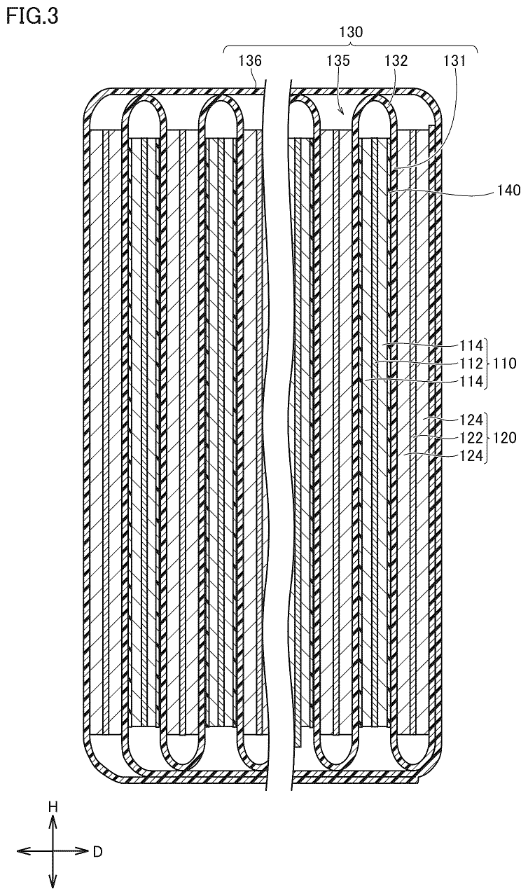

FIG. 3 is a cross-sectional view showing an example of an electrode assembly according to the present embodiment. The electrode assembly 100 includes one or more first electrodes 110, one or more second electrodes 120, one or more separators 130, and an interposition film 140. In the thickness direction, the first electrodes 110 and the second electrodes 120 are alternately stacked. That is, the thickness direction is parallel to the stacking direction of the first electrode 110 and the second electrode 120. The number of the first electrodes 110 and the number of the second electrodes 120 may be 2 or more, 5 or more, 10 or more, 50 or more, or 100 or more. The number of the first electrodes 110 and the number of the second electrodes 120 may be 200 or less, 100 or less, 50 or less, 10 or less, or 5 or less.

The second electrode 120 has a polarity different from that of the first electrode 110. For example, the first electrode 110 may be a positive electrode and the second electrode 120 may be a negative electrode. For example, the first electrode 110 may be a negative electrode and the second electrode 120 may be a positive electrode.

The first electrode 110 may include, for example, a first current collector 112 and a first active material layer 114. The first current collector 112 may include, for example, a metal foil. The metal foil may include, for example, Al, Cu, Ni, Ti, Fe, or the like. The first active material layer 114 is disposed on the surface of the first current collector 112. The first active material layer 114 may be disposed only on one surface of the first current collector 112. The first active material layer 114 may be disposed on both surfaces of the first current collector 112. The first active material layer 114 includes a positive electrode active material or a negative electrode active material. The positive electrode active material may contain, for example, a lithium-nickel composite oxide. The negative electrode active material may contain, for example, graphite, SiO, Si, or the like.

The second electrode 120 may include, for example, a second current collector 122 and a second active material layer 124. The second current collector 122 may include, for example, a metal foil. The second active material layer 124 is disposed on the surface of the second current collector 122. The second active material layer 124 may be disposed only on one surface of the second current collector 122. The second active material layer 124 may be disposed on both surfaces of the second current collector 122. The second active material layer 124 includes a positive electrode active material or a negative electrode active material. The second active material layer 124 may have the same area as the first active material layer 114 or may have a different area. For example, the area of the second active material layer 124 may be larger than the area of the first active material layer 114. The ratio of the area of the second active material layer 124 to the area of the first active material layer 114 may be, for example, 1.01 or more, 1.05 or more, or 1.1 or more. The ratio of the area of the second active material layer 124 to the area of the first active material layer 114 may be, for example, 1.1 or less, 1.05 or less, or 1.01 or less.

### —Separator—

The separator 130 has electrical insulation properties. The separator 130 is porous. The separator 130 may include, for example, a microporous film made of polyolefin. The thickness of the separator 130 may be any of, for example, 5 to 50 μm, 5 to 30 μm, or 5 to 15 μm. The separator 130 separates the first electrode 110 from the second electrode 120. The number of separators 130 may be, for example, two or more. For example, one separator 130 may be inserted between the first electrode 110 and the second electrode 120.

The number of separators 130 may be, for example, one. For example, the separator 130 may include a serpentine portion 135. In the serpentine portion 135, the separator 130 is folded in a serpentine manner. The serpentine portion 135 includes a planar portion 131 and a folded-back portion 132. In the planar portion 131, the separator 130 extends in a planar shape. In the folded-back portion 132, the separator 130 is folded back. The folded-back portions 132 are disposed at both ends in the height direction. The separator 130 is folded back so as to alternately sandwich the first electrode 110 or the second electrode 120. The planar portion 131 sandwiches the first electrode 110 or the second electrode 120. The separator 130 may further include, for example, an outer peripheral portion 136. The outer peripheral portion 136 may be wound so as to wrap around the serpentine portion 135. The serpentine portions may be formed by folding back the separators 130 at both ends in the width direction.

### —Interposition Film—

The interposition film 140 is interposed at least between the first electrode 110 and the separator 130. The interposition film 140 may be interposed between the second electrode 120 and the separator 130. The interposition film 140 may be porous. The porosity of the interposition film 140 may be higher or lower than the porosity of the separator 130. The average pore diameter of the interposition film 140 may be higher or lower than the average pore diameter of the separator 130.

The interposition film 140 may include, for example, a heat-resistant material. The interposition film 140 may include, for example, inorganic particles and a binder. The interposition film 140 may comprise, for example, 0.1 to 50% binder and the remainder of the inorganic particles in mass fractions. The mass fraction of the binder may be any of, for example, 1 to 30%, 1 to 10%, 1 to 5%, or 1 to 3%.

The inorganic particles may include, for example, at least one selected from the group consisting of alumina, boehmite, titania, magnesia, silica, and zirconia. The binder may contain, for example, at least one selected from the group consisting of polyvinylidene difluoride, vinylidene difluoride-hexafluoropropylene copolymer, styrene-butadiene rubber, carboxymethyl cellulose, polyvinyl alcohol, polyvinyl butyral, polyethylene oxide, polyacrylic acid, acrylic-based resin, and methacrylic-based resin.

The interposition film 140 may be, for example, a self-standing film. A “self-standing film” refers to a film that maintains its own shape. The interposition film 140 may be, for example, a non-self-standing film. A “non-self-standing film” refers to a film that is supported by a support to maintain its shape. For example, the interposition film 140 may be supported by at least one of the first electrode 110 and the separator 130. That is, the interposition film 140 may be formed on at least one surface of the first electrode 110 and the separator 130. For example, an interposition film 140 may be formed by applying a heat-resistant material to the surface of the separator 130. For example, the interposition film 140 may be formed by applying a heat-resistant material to the surface of the first electrode 110. For example, an interposition film 140 may be formed by applying a heat-resistant material to the surfaces of both the first electrode 110 and the separator 130. When the separator 130 includes the serpentine portion 135, the interposition film 140 may be formed only on the planar portion 131, or may be formed on both the planar portion 131 and the folded-back portion 132.

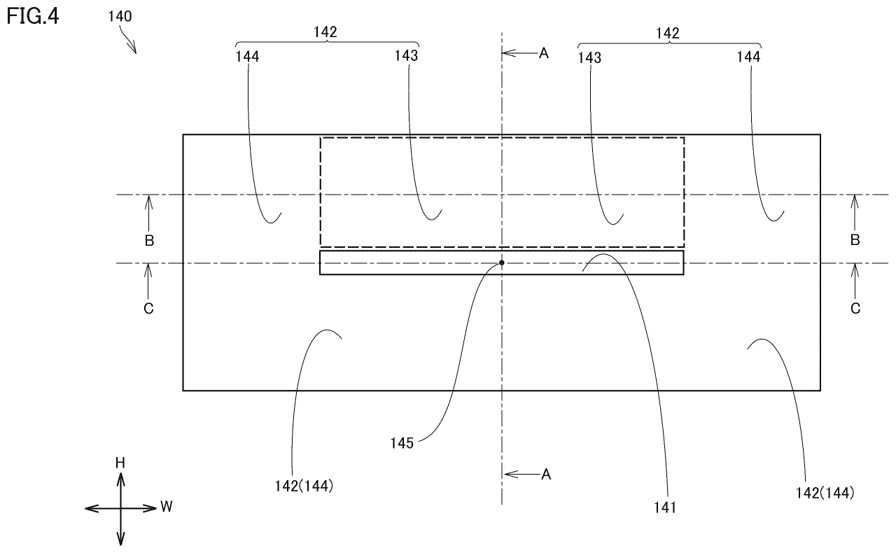

FIG. 4 is a schematic plan view showing an example of an interposition film. FIG. 4 shows a plane orthogonal to the stacking direction (thickness direction). The same plane is parallel to the height direction and the width direction. The interposition film 140 includes a first region 141 and a second region 142. The first region 141 includes a center 145 of the interposition film 140. The “center” indicates the geometric center of the figure formed by the outline of the interposition film 140. The first region 141 is a thick portion. The first region 141 may inhibit movement of the electrolyte solution. Since the first region 141 inhibits the movement of the electrolyte solution, unevenness of the retention amount of the electrolyte solution is expected to be reduced.

The first region 141 may extend in the width direction, for example. The ratio of the width of the interposition film 140 to the width of the electrode assembly 100 may be, for example, 0.25 or more, 0.5 or more, or 0.75 or more. The ratio of the width of the interposition film 140 to the width of the electrode assembly 100 may be, for example, 0.75 or less, 0.5 or less, or 0.25 or less. The ratio of the height of the interposition film 140 to the height of the electrode assembly 100 may be, for example, 0.01 or more, 0.05 or more, 0.1 or more, 0.2 or more, or 0.3 or more. The ratio of the height of the interposition film 140 to the height of the electrode assembly 100 may be, for example, 0.3 or less, 0.2 or less, 0.1 or less, 0.05 or less, or 0.01 or less.

The second region 142 surrounds the first region 141. The second region 142 may include, for example, a third region 143 and a fourth region 144. In the height direction, the first region 141 is disposed between the third region 143 and the fourth region 144. The third region 143 is a thin portion. An electrolyte solution may be stored in the third region 143.

For example, the third region 143 may be positioned vertically above the first region 141. When the height direction is parallel to the vertical direction, the holding amount of the electrolyte solution tends to decrease most easily in the region above the first region 141. For example, the larger the first aspect ratio of the electrode assembly 100, the more prominent the tendency. Since the region is a thin portion (a storage portion of the electrolyte solution), unevenness of the retention amount of the electrolyte solution is expected to be reduced.

The fourth region 144 may be adjacent to the third region 143. The fourth region 144 may be adjacent to the first region 141. The fourth regions 144 may be disposed on both sides of the third region 143 in the width direction. In the width direction, the fourth regions 144 may be disposed on both sides of the first region 141. The fourth region 144 may be positioned vertically below the first region 141.

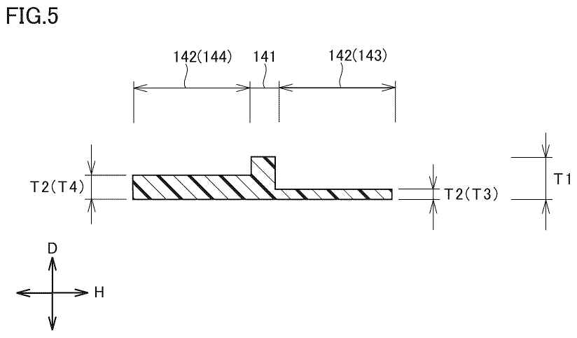

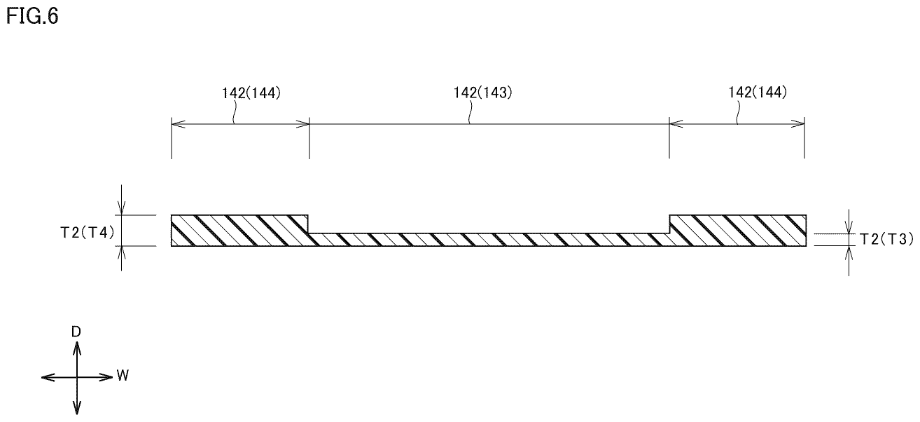

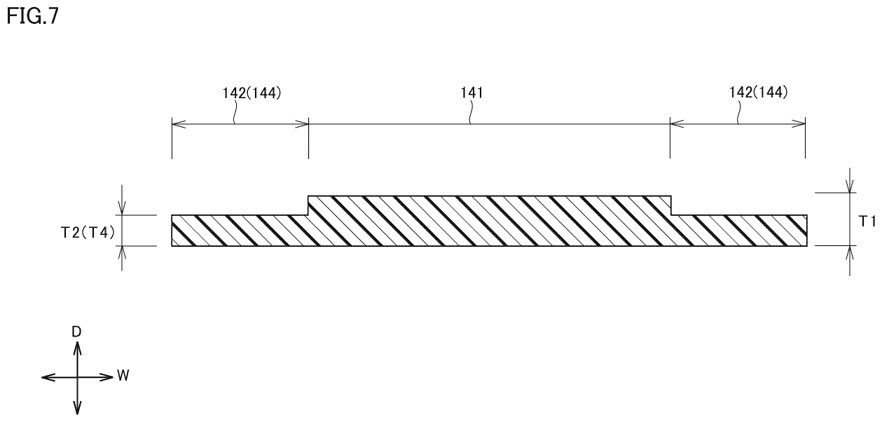

FIG. 5 is a cross-sectional view taken along line A-A of FIG. 4. FIG. 6 is a cross-sectional view taken along the line B-B of FIG. 4. FIG. 7 is a cross-sectional view taken along the line C-C of FIG. 4. The interposition film 140 satisfies the relationship of the following formula (1).

T2<T1 (1)
T1 denotes the thickness of the interposition film 140 in the first region 141. T2 denotes the thickness of the interposition film 140 in the second region 142.

The ratio (T1/T2) of T1 to T2 may be, for example, 1.01 or more, 1.05 or more, 1.1 or more, 1.2 or more, 1.5 or more, or 2 or more. The ratio (T1/T2) may be any of, for example, 3 or less, 2 or less, 1.5 or less, 1.2 or less, 1.1 or less, or 1.05 or less.

The interposition film 140 may satisfy, for example, the following formula (2).

T3<T4 (2)
T3 represents the thickness of the interposition film 140 in the third region 143. T4 represents the thickness of the interposition film 140 in the fourth region 144.

The ratio (T3/T4) of T3 to T4 may be, for example, 0.99 or less, 0.95 or less, 0.90 or less, 0.75 or less, or 0.5 or less. The ratio (T3/T4) may be, for example, 0.3 or more, 0.5 or more, 0.75 or more, 0.90 or more, or 0.95 or more.

When the above formula (2) is satisfied, the following formula (2)′ is also satisfied.

$$T 3 < T 4 \leq T 2 \qquad {( 2 )}^{′}$$

The interposition film 140 may satisfy, for example, the following formulas (3) and (4).

$$10 μm \leq T 1 \leq 20 μm \qquad ( 3 )$$

$$T 3 \leq 3 μm \qquad ( 4 )$$

T1 may be, for example, 11 μm or more, 12.5 μm or more, 15 μm or more, 17.5 μm or more, or 19 μm or more. T1 may be equal to or less than 17.5 μm, equal to or less than 15 μm, equal to or less than 12.5 μm, or equal to or less than 11 μm.

T3 may be, for example, 2.5 μm or less, 2 μm or less, 1.5 μm or less, 1 μm or less, 0.5 μm or less, or 0.1 μm or less. T3 may be, for example, 0.1 μm or more, 0.5 μm or more, 1 μm or more, 1.5 μm or more, 2 μm or more, or 2.5 μm or more.

T4 (T2) may be, for example, more than 3 μm, 3.5 μm or more, 4 μm or more, 5 μm or more, 6 μm or more, 7 μm or more, 8 μm or more, or 9 μm or more. T4 (T2) may be, for example, less than 10 μm, 9 μm or less, 8 μm or less, 7 μm or less, 6 μm or less, 5 μm or less, 4 μm or less, or 3.5 μm or less.

### —Case—

The case 200 houses the electrolyte solution and the electrode assembly 100. The case 200 may be sealed. The case 200 may be sealed. The case 200 may include, for example, a can 210 and a lid 220. The can 210 has an opening. The opening is open in the height direction. The opening may be open vertically upward, for example. The can 210 may be made of metal, for example. The can 210 may include, for example, Al or the like. The can 210 may include, for example, a bottom wall 212 and a peripheral wall 214. The bottom wall 212 may have, for example, a flat plate shape. The planar shape of the bottom wall 212 may be rectangular, for example. The peripheral wall 214 rises from the bottom wall 212. The peripheral wall 214 may be, for example, a quadrangular tube. The width of the peripheral wall 214 may be greater than the thickness of the peripheral wall 214. The height of the peripheral wall 214 may be greater than the thickness of the peripheral wall 214. Here, the “thickness of the peripheral wall 214” indicates the outer dimension of the case 200 in the thickness direction.

The lid 220 closes the opening of the can 210. The lid 220 may be welded to the peripheral wall 214. The lid 220 may have, for example, a flat plate shape. The lid 220 may be made of metal, for example. The lid 220 may include, for example, Al or the like. The lid 220 may include, for example, a pressure release valve 222 and a sealing member 224.

The pressure release valve 222 may be disposed, for example, near the center of the lid 220. The pressure release valve 222 releases the internal pressure of the case 200. When the internal pressure is greater than or equal to the set value, the pressure release valve 222 may be opened. The sealing member 224 seals the injection port 221. The electrolyte solution may be injected from the injection port 221.

The pair of external terminals 300 is fixed to the lid 220. The external terminal 300 is connected to the first electrode 110 or the second electrode 120. The external terminal 300 may be made of metal, for example. The external terminal may include Al, Cu, Ni, or the like. The external terminal may have, for example, a rectangular parallelepiped outer shape. The external terminal 300 may be connected to a bus bar (not shown).

The pair of coupling members 400 connects the electrode tabs to the external terminals 300. The electrode tab indicates a first electrode tab 116 or a second electrode tab 126. The two coupling members 400 may have substantially the same structure.

The coupling member 400 may include, for example, a current collecting tab 410, a sub-tab 420, and a coupling pin 430. The current collecting tab 410 includes a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub-tab 420 connects a plurality of electrode tabs to the current collecting tab 410. The sub-tab 420 may include a first end portion 422 and a second end portion 424. The first end portion 422 is connected to a plurality of electrode tabs. The second end portion 424 is connected to the lateral portion 412.

The coupling pin 430 connects the current collecting tab 410 to the external terminal 300. The coupling pin 430 connects the upper portion 414 and the external terminal 300. For example, the lower end of the coupling pin 430 may be inserted through a through hole formed in the upper portion 414.

### —Insulating Member—

The insulating member 500 insulates the case 200 from the coupling member 400. The insulating member 500 may include, for example, a first portion 510, a second portion 520, a third portion 530, and a fourth portion 540.

The first portion 510 is fixed to the upper surface of the lid 220. The first portion 510 is disposed between the lid 220 and the external terminal 300. The second portion 520 is fixed to the lower surface of the lid 220. The second portion 520 is disposed between the lid 220 and the upper portion 414. The second portion 520 is disposed between the lid 220 and the lower portion of the coupling pin 430. The third portion 530 is disposed between the coupling pin 430 and the lid 220. The third portion 530 is cylindrical. The third portion 530 surrounds the coupling pin 430. Through holes are formed in the first portion 510, the second portion 520, and the third portion 530. The coupling pin 430 is inserted through the through hole.

The fourth portion 540 has a plate shape. It is fixed to the lower surface of the upper portion 414. The fourth portion 540 is disposed above the electrode assembly 100. In the fourth portion 540, a through hole is formed below the pressure release valve 222. In the fourth portion 540, a through hole is also formed below the injection port 221.

What is claimed is:

1. A power storage cell comprising:
a case;
an electrolyte solution; and
an electrode assembly, wherein
the case houses the electrolyte solution and the electrode assembly,
the electrode assembly includes a first electrode, a second electrode, a separator, and an interposition film,
the first electrode and the second electrode are alternately stacked,
the separator separates the first electrode from the second electrode,
the interposition film is interposed between the first electrode and the separator,
in a plane orthogonal to a stacking direction of the first electrode and the second electrode,
the interposition film includes a first region and a second region,
the first region includes a center of the interposition film in the plane,
the second region surrounds a periphery of the first region, and
the interposition film satisfies a relationship of the following formula (1):
T2<T1 (1), where
T1 represents a thickness of the interposition film in the first region, and
T2 represents a thickness of the interposition film in the second region.

2. The power storage cell according to claim 1, wherein
the power storage cell has a height direction, a width direction and a thickness direction,
the height direction, the width direction, and the thickness direction are orthogonal to one another,
the thickness direction is parallel to the stacking direction,
in the plane orthogonal to the stacking direction,
the first region extends in the width direction,
the second region includes a third region and a fourth region, and
the first region is disposed between the third region and the fourth region in the height direction, and
the interposition film further satisfies a relationship of the following formula (2):
T3<T4 (2), where
T3 represents a thickness of the interposition film in the third region,
T4 represents a thickness of the interposition film in the fourth region.

3. The power storage cell according to claim 2, wherein
the interposition film further satisfies relationships of the following formulas (3) and (4):
$$10 μm \leq T 1 \leq 20 μm ; and \qquad ( 3 )$$
$$T 3 \leq 3 μm . \qquad ( 4 )$$

4. The power storage cell according to claim 2, wherein
the interposition film is formed on a surface of at least one of the first electrode and the separator,
the interposition film is porous, and
the interposition film includes an inorganic particle and a binder.

5. The power storage cell according to claim 2, wherein
the separator includes a serpentine portion,
in the serpentine portion, the separator is folded in a serpentine manner,
the separator is folded back at both ends in the height direction, and
the separator is folded back to alternately sandwich the first electrode or the second electrode.
